(19) United States
(12) Patent Application Publication
(10) Pub. No.: US 2009/0187423 A1
(43) Pub. Date: Jul. 23, 2009

(54) Method for online management of medical record forms

(75) Inventor: Suhung-Gwon Kim, Seoul (KR)

Correspondence Address: STERNE, KESSLER, GOLDSTEIN & FOX P.L.L.C., 1100 NEW YORK AVENUE, N.W., WASHINGTON, DC, 20005, US

(73) Assignees: EZ-Caretech Co., Ltd., Jongno-gu, Seoul (KR); Seoul National University Hospital, Seoul (KR)

(21) Appl. No.: 10/564,561

(22) PCT Filed: Jul. 13, 2004
(86) PCT No.: PCT/KR04/01733

§ 371 Date: Nov. 30, 2006

(30) Foreign Application Priority Data
Jul. 14, 2003 (KR) 10-2003-0047693

(51) Int. Cl. G06Q 50/00; G06F 3/048; G06F 17/00

(52) U.S. Cl. 705/3; 715/224; 715/810; 715/760

(57) ABSTRACT

An object of the present invention is to provide a method for the online management of medical record forms, which can provide web screens through terminals to enable doctors, nurses, pharmacists, or the like to immediately online input and read a variety of information created upon treating and caring for patients in a hospital, and can add, modify, delete or manage various medical record forms provided on the web screens and images inserted into records.

### TECHNICAL FIELD

The present invention relates to a method which can computerize a variety of medical information, such as treatment information, nursing information and medicine information, required in medical institutions, and perform the online management of medical record forms for representing the medical information.

### BACKGROUND ART

As various kinds of networks such as the Internet as a worldwide network, LANs and the Intranet have advanced, there have been developed techniques and contents for enabling a variety of information to be shared over these networks.

Such technical advancement has also occurred in the medical industry, and techniques for sharing a variety of information over an internal network are being developed.

However, information sharing currently available within a hospital only allows the sharing of simple contents, such as personnel matters of users, treatment items, treatment reservation information, treatment particulars information and hospitalization information. In addition, only orders that doctors issue to patients after treatment, for example, information on whether to prepare which and how much medicine, whether to inject what injection, and whether to perform what examination, are being currently shared over these networks.

However, the most important information in the treatment and care of patients in a hospital is not the above listed information but individual status information depending on the disease symptoms of respective patients, such as nursing diaries written by nurses who observe the disease symptoms of patients, treatment opinions and treatment methods of doctors, and test and treatment results.

Meanwhile, the aforementioned information may be provided through charts written by doctors upon treating a patient, nursing diaries written by nurses upon caring for a patient, or various reports written by laboratory staff upon the testing or treatment of a patient.

However, there is a problem in that since there are a variety of contents to be input for respective clinical departments as well as a variety of means of acquisition for the aforementioned individual status information depending on the disease symptoms of the respective patients, such information cannot be indiscriminately standardized and computerized. Thus, there are currently no methods capable of sharing the aforementioned information over a hospital network.

In other words, there is a problem in that patient information cannot be managed more efficiently since the aforementioned individual status information depending on the patient's disease symptom are written in and managed through paper charts, even though network and computer techniques are being developed, and contents written in the paper charts are merely computerized by separate staff or systems.

There is a problem in that since the aforementioned information is not computerized, more rapid and accurate medical services cannot be provided to patients as patients are being examined or treated.

Further, there is a problem in that systematic management through computerization is difficult since new forms of charts are constantly required, in addition to the fact that there are innumerable paper charts being currently used to write medical information at each individual department even in the same hospital.

### DISCLOSURE OF INVENTION

The present invention is conceived to solve the aforementioned problems. An object of the present invention is to provide a method for the online management of medical record forms, which can provide web screens through terminals to enable doctors, nurses, pharmacists, or the like to immediately online input and read a variety of information created upon the treatment and care of patients in a hospital, and can add, modify, delete or manage various medical record forms provided on the web screens and images inserted into the record forms.

### BRIEF DESCRIPTION OF DRAWINGS

FIG. 1 is a diagram illustrating the configuration of an embodiment of a medical information-providing system to which the present invention is applied.

FIG. 2a is a diagram illustrating an example of a doctor web screen to which the method for the online management of medical record forms according to the present invention is applied.

FIG. 2b is a diagram illustrating another example of a doctor web screen to which the method for the online management of medical record forms according to the present invention is applied.

FIG. 3 is a diagram illustrating an example of a web page dialog box for medical record form registration, which is applied to the method for the online management of medical record forms according to the present invention.

FIG. 4 is a diagram illustrating an example of a web page dialog box for setting basic values of medical record forms that is applied to the method for the online management of medical record forms according to the present invention.

FIG. 5a is a diagram illustrating another example of a doctor web screen that is applied to the method for the online management of medical record forms according to the present invention.

FIG. 5b is a diagram illustrating an example of a web page dialog box for image management that is applied to the method for the online management of medical record forms according to the present invention.

FIG. 6a is a diagram illustrating an example of a doctor web screen that implements the method for the online management of medical record forms according to the present invention.

FIG. 6b is a diagram illustrating another example of a doctor web screen that implements the method for the online management of medical record forms according to the present invention.

### BEST MODE FOR CARRYING OUT THE INVENTION

According to the present invention for achieving the aforementioned objects, there is provided a method for the online management of medical record forms, which is applied to a medical information-providing system, comprising a fourth step of providing a selected medical record form as a default record form through a web screen.

Hereinafter, preferred embodiments of the present invention will be described in detail with reference to the accompanying drawings.

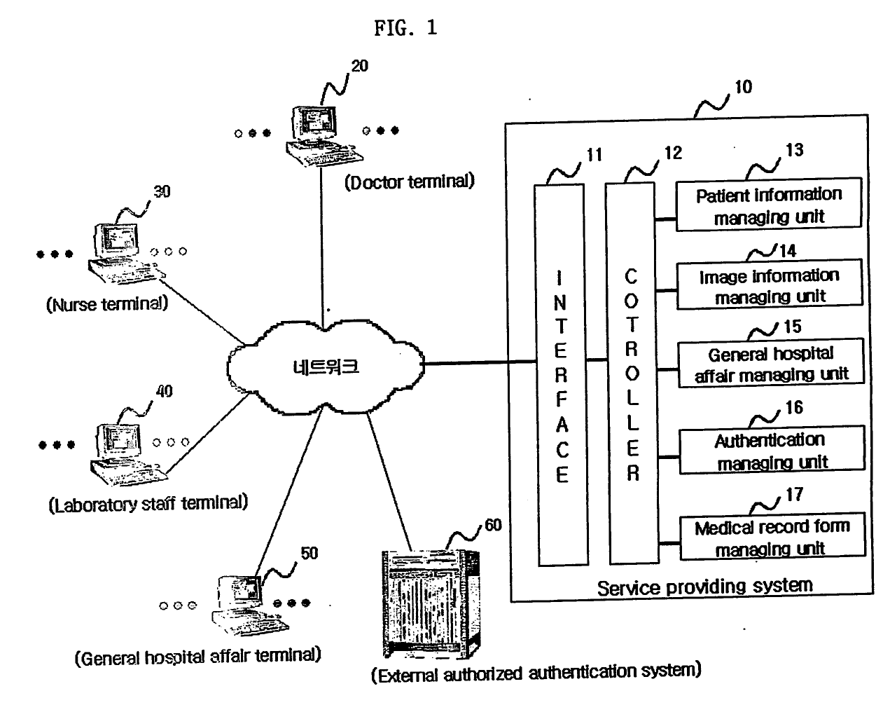

FIG. 1 is a diagram illustrating the configuration of an embodiment of a medical information-providing system to which the present invention is applied.

As shown in the figure, the medical information-providing system to which the present invention is applied comprises a service-providing system 10 for managing and providing information on patients and managing general task information of a hospital through a network; a doctor terminal 20 for allowing doctors to connect to the service-providing system, read a variety of information on patients, and input treatment results; a nurse terminal 30 for allowing nurses to connect to the service-providing system, read the information on patients, or input treatment results; an laboratory staff terminal 40 for allowing various laboratory staff in the hospital to connect to the service-providing system, read information on a request for examination of patients, and input examination results into the service-providing system; a general hospital affair terminal 50 for allowing general staff responsible for general tasks in the hospital to connect to the service-providing system, and read or input a variety of information related to the hospital tasks; and an external authorized authentication system 60 for performing user authentication when the terminals are intended to be connected to the service-providing system.

At this time, a treatment task by a doctor, a nursing task by a nurse, and an examination task by a laboratory staff may be regarded as being performed on web screens of the doctor terminal 20, the nurse terminal 30 and the laboratory staff terminal 40, respectively. For the sake of convenience of illustration, the web screens executed by the respective terminals are called a doctor web screen, a nurse web screen and a laboratory web screen, respectively.

Hereinafter, the present invention will be described on the assumption that the service-providing system 10, the doctor terminal 20, nurse terminal 30 and the laboratory staff terminal 40 are connected over an internal network (Intranet) built into the hospital (hereinafter, briefly referred to as “Intranet”). However, the present invention is not limited thereto and the terminals may be connected and operated over a network such as the Internet.

Now, the Intranet will be described briefly below.

The Intranet refers to a group of networks, which are permanently connected to one another to create a more extended network, or a single network in a computing environment. The Intranet is a slightly different concept from that of a LAN (or WAN) owned by one group or the Internet that is a public network. That is, the Intranet uses TCP/IP for communication as well as using Internet techniques unlike a LAN. There is a difference between the Internet and an Intranet in that the Internet is a public network while an Intranet is a private network capable of blocking an intruder with a firewall.

Further, an Intranet may be much more complex than the Internet in that the Intranet is required to seamlessly interconnect several local networks which use different protocols and on which intelligent business applications are executed. Meanwhile, a user who has connected to an intranet is allowed to connect to the Internet while connections from the Internet to the Intranet are limited, wherein only controlled access is permitted.

Further, as described above, an Intranet is different from a typical LAN in that the Intranet uses an Internet standard. Accordingly, in the case where a doctor, a nurse, an laboratory staff, or the like desires to connect to the service-providing system 10 using his/her terminal, he/she will connect to the system by driving a web browser as in an Internet connection method.

Further, according to the present invention, since a method for receiving various data from the service-providing system using the Internet based web browser as described above is used, storage mediums inside the doctor terminal 20, the nurse terminal 30, and the laboratory staff terminal 40 need not have any program and data for driving an application according to the present invention.

Further, although the general hospital affair terminal 50 and the service-providing system may be connected to each other by the Internet or an Intranet as described above, the present invention will be described by assuming that the general hospital affair terminal 50 and service-providing system are connected to each other by a general internal network such as LAN. At this time, if they are connected to each other by the general internal network as described above, software for receiving various provided information according to the present invention must be installed in the general hospital affair terminal 50.

Meanwhile, in order to provide service according to the present invention, the service-providing system 10 includes an interface 11, a control unit 12, a patient information-managing unit 13, an image information-managing unit 14, a general hospital affair managing unit 15, and an authentication-managing unit 16.

First, the interface 11 performs a function of connecting with the respective terminals 20, 30, 40 and 50, and the external authorized authentication system 60 via the network. That is, the interface 11 performs a connection via the Intranet with the doctor terminal 20, the nurse terminal 30 and the laboratory staff terminal 40, while performs a function to allow Internet connection if there is an Internet connection request from the terminals. Further, the interface 11 may be connected with the general hospital affair terminal 50 over the internal network such as the LAN. Further, as described above, the interface may be connected with the external authorized authentication system 60 over the Internet.

Next, the patient information-managing unit 13 performs a function of managing patient information (medical information) input from at least one of the doctor terminal 20, the nurse terminal 30, the laboratory staff terminal 40, and the general hospital affair terminal 50, and of extracting and transmitting medical information on a relevant patient if there is an information request for the relevant patient from the doctor terminal 20.

Next, the image information-managing unit 14 performs a function of managing image information input from at least one of the above respective terminals, and of extracting and transmitting image information on a relevant patient if there is an image information request for the relevant patient from the doctor terminal 20. Typically, the image information refers to images obtained by electronically imaging various photographs or the like photographed to examine patient states, such as X ray photographs, endoscope photographs, CT photographs, and the like. The image information includes images obtained by scanning various documents, photographs, or the like as well as the aforementioned photographs.

Next, the general hospital affair managing unit 15 performs a function of managing hospital affair related information input through the general hospital affair terminal 50 by staff responsible for general management tasks of the hospital, and of transmitting hospital affair related information to the relevant terminal if there is a request to output the information from at least one of the general hospital affair terminal 50 and other terminals 20, 30 and 40.

Next, the authentication-managing unit 16 performs a function of performing authentication on respective users that enter the service-providing system 10 over the network (e.g., Internet or Intranet). That is, if a doctor, a nurse, laboratory staff, and a general hospital task staff desire to connect to the service-providing system 10 using their terminal, the authentication-managing unit 16 performs a function of permitting a connection only to authenticated users by performing an authentication procedure to confirm whether they are users authorized to access. Meanwhile, for a system that manages patient information in a hospital like the service-providing system, it needs thorough security, wherein sufficient security may not be provided only by self-authentication. Accordingly, in this case, an authentication procedure may be performed by the external authorized authentication system 60 other than the internal authentication system connected to the Intranet. That is, if there is an authentication request from a user, the authentication-managing unit 16 transmits the user information to the external authorized authentication system 60 over a network such as the Internet to perform the authentication procedure, and then determines whether to allow connection based upon the authentication result.

Next, the medical record form-managing unit 17 performs the function of managing information on various record forms provided through the doctor web screen, the nurse web screen, and the laboratory web screen. That is, the medical record form-managing unit 17 performs the function of computerizing and managing various record forms that have been conventionally used in the form of paper charts, and provides the record forms online to the web screens when there is a request for the record forms from the web screens. At this time, the forms are forms into and from which medical information on patients such as various treatment information, nursing information, and examination record information on patients is input or read, and refer to forms that can be implemented through a web screen instead of a conventionally used paper chart (hereinafter, referred briefly to as a “medical record form”).

Meanwhile, although the present invention will be described by way of example in conjunction with a method for managing medical record forms provided through a doctor web screen among other record forms described above, the present invention is not limited thereto, but can be likewise applied to a variety of medical record forms provided through a nurse web screen or an laboratory web screen.

Finally, the control unit 12 performs a function of controlling the interface and respective units 13 to 17, and transmitting or receiving a variety of information to or from the terminals over the network.

At this time, the interface and the respective units 12 to 16 may be implemented by one computer or server, and have a secondary system to stand ready in case of failure.

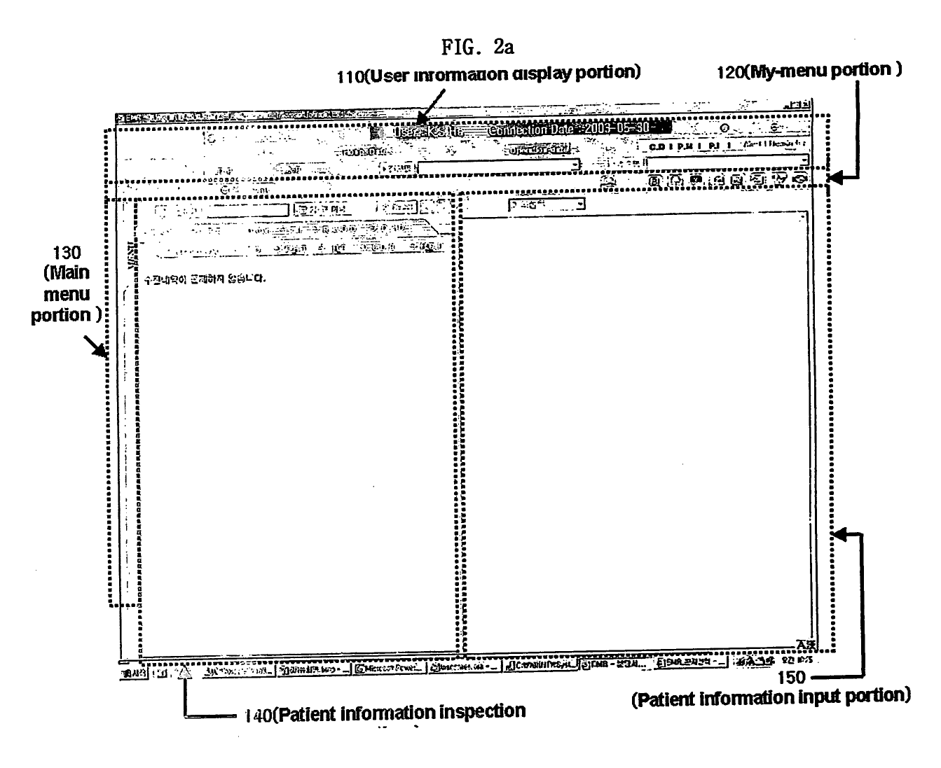

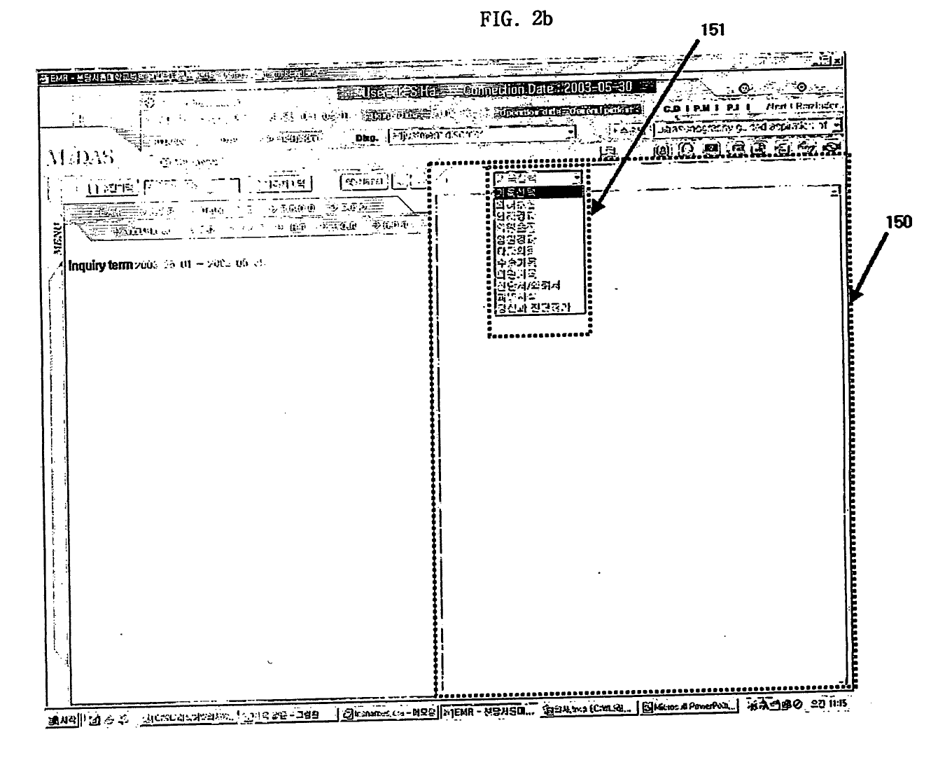

FIG. 2a is a diagram illustrating an example of a doctor web screen to which a method for the online management of medical record forms according to the present invention is applied, and is a diagram illustrating an example of an initial screen for providing various medical information when a doctor has been connected to the service-providing system using the doctor terminal 20 and has been subject to a normal login process.

That is, the doctor can connect to the service-providing system 10 via a web browser and can normally receive various provided information after being subject to an authentication process through the authentication-managing unit 16 inside the service-providing system or the external authorized authentication system 60.

Meanwhile, an example of a web browser screen is shown in FIG. 2a, which is activated when the doctor selects a [doctor management screen] menu after connecting to the service-providing system 10 through a normal login. As shown, the doctor web screen is divided into five blocks of a user information display portion 110, a my-menu portion 120, a main menu portion 130, a patient information inspection portion 140, and a patient information input portion 150.

First, the user information display portion 110 will output information on doctors (i.e., user) currently logged in and selected patient information.

Next, displayed in the my-menu portion 120 is a shortcut icon set for a menu that is frequently used by each user (i.e., doctor) among a number of menus in the main menu portion 130.

Next, the main menu portion 130 has all menus that can be used by the doctor or the manager managing the doctor web screen. That is, the main menu portion 130 includes menus for various screens that can be displayed on the doctor web screen and, particularly, includes menus capable of managing medical record forms which are applied to the present invention.

Next, the patient information inspection portion 140 is a block in which a user (doctor) can read detailed information on patients stored in the patient information-managing unit 13. As shown, the patient information inspection portion 140 is configured to allow the inspection of information on first ambulatory treatment, ambulatory progression, order, examination inquiry, requests by other departments, department-based documents, vital sheets, nursing diaries, first hospitalization treatment, hospitalization results, surgical operation records, hospital discharge records, and the like. Meanwhile, in FIG. 2a, the patient information inspection portion 140 is in a state in which any information has not been selected for inspection, and thus, is displayed as a blank state.

Finally, the patient information-input portion 150 is a block in which the doctor can input a variety of information needed while caring for a patient. The information input via the patient information input portion 150 can be read through the patient information inspection portion 140.

FIG. 2b is a diagram illustrating another example of a doctor web screen to which a method for the online management of medical record forms according to the present invention is applied, and the doctor web screen is an exemplary one for explaining the patient information input portion 150 in the doctor web screen shown in FIG. 2a.

That is, the patient information input portion 150 as shown in FIG. 2b is a block in which a doctor can input treatment information on a patient while treating the patient. It is systematically configured so that the doctor can input information using a computer rather than the conventional paper charts. For this purpose, the patient information input portion 150 may include first ambulatory treatment, ambulatory progression, first hospitalization treatment, hospitalization progression, requests by other departments, surgical operation records, and hospital discharge record menus within the record selection column 151 to allow input of care results upon first ambulatory treatment, care results depending on ambulatory progression, information needed upon first hospitalization treatment, treatment information created by hospitalization progression, information on requests for other departments, patient information resulting from surgical operations, and information needed upon hospital discharge.

At this time, the menus are menus that can be used by all doctors in common (hereinafter, referred briefly to as “common menus”). In addition to these common menus, a medical certificate/written request menu is included in the record selection column 151 since various medical certificate/written requests are required to be made depending on doctors. Further, in addition to the menus, there may be documents required for each clinical department. According the present invention, a department based record form menu is included in the record selection column 151 since a definite form cannot be made for these record forms collectively, such that a form required by each clinical department is created and used. That is, if a user selects the department based record form menu, a separate definite form is not output, but an additional form may be output for allowing a specific record form for each clinical department to be directly created. In addition, according to the present invention, a psychiatric department diagnosis evaluation menu is included in the record selection column 151 to allow separate management of such record forms since the psychiatric department requires various types of record forms unlike other clinical departments. Meanwhile, according to the present invention, patient information input through each menu of the record selection column 151 is can be read through each menu of the patient information inspection portion 140.

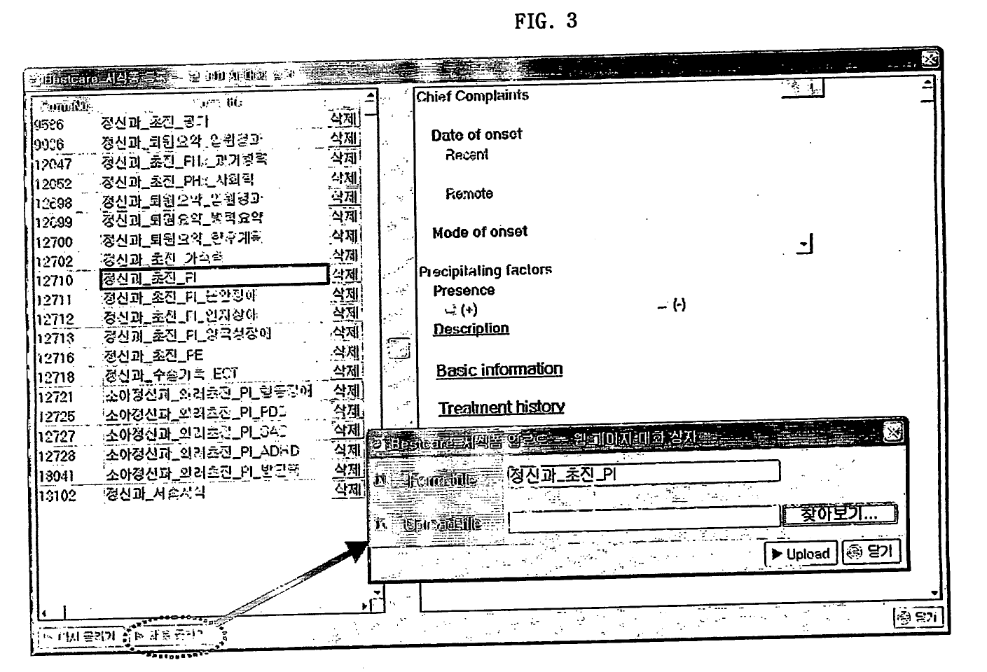

FIG. 3 is a diagram illustrating an example of a web page dialog box for medical record form registration that is applied to a method for the online management of medical record forms according to the present invention.

As described above, the patient information input portion 150 of the doctor web screen includes a common menu that will be used in common by doctors, such as first ambulatory treatment, ambulatory progression, first hospitalization treatment, hospitalization progression, requests by other departments, surgical operation records, and hospital discharge records. If the user selects a relevant menu, a medical record form for the relevant menu is fetched from the medical record form-managing unit 17 and is output on the patient information input portion 150. At this time, since the menus include sub-menus (e.g., items and the like for inputting chief complaints, social history, past medical history, family history, and the like) therein, such as the first ambulatory treatment menu or the first hospitalization treatment menu, separate medical record forms for each sub-menu may be required.

Meanwhile, although the respective medical record forms provided by the common menu are of some patterned form, there may be medical record forms that are newly required depending on new diseases and patient states, as described above.

Further, the department-based documents or medical record forms provided by the medical certificate/written request menu themselves do not have patterned forms, and it is required for a user to manufacture new medical record forms for each clinical department or depending on the type of medical certificates and written requests.

That is, FIG. 3 illustrates a n example of a web page dialog box to allow respective doctors or managers who manage doctor web screens to register desired medical record forms with the medical record form-managing unit 17 of the service-providing system.

At this time, the dialog box as shown in FIG. 3 may be provided through the menus in the main menu portion 130, wherein authority to use the dialog box may be limited. That is, the respective doctors may register desired medical record forms through the above-stated dialog box but managers authorized to register the medical record forms may be present for the respective departments, in which only the managers can perform a procedure for registering medical record forms.

That is, since each doctor must input his/her ID and password to login to the doctor web screen, it is possible for the control unit 12 of the service-providing system to determine whether the user is authorized to use the dialog box, based on the ID.

Further, in the case where a user who is authorized to register medical record forms registers medical record forms through the above dialog box, since newly registered medical record forms must be registered along with related clinical department information and medical record forms, the control unit 12 can automatically designate a folder in which the medical record forms registered by the user must be stored if the user activates the dialog box. However, the present invention is not limited thereto but can also allow a user to directly select the folder.

Further, according to the present invention, as shown in FIG. 3, the user is allowed to read all medical record forms in the folder for which the user is authorized to register or delete the medical record forms, thereby facilitating deletion or registration. That is, the dialog box shown in FIG. 3 is a screen on which doctors belonging to a psychiatric department can newly register or delete medical record forms. According to the present invention, the user can read various medical record forms belonging to the psychiatric department, such that the user deletes unnecessary medical record forms and newly uploads necessary medical record forms via the above-stated dialog box.

Meanwhile, as will be understood from the figure, the dialog box includes a list of medical record forms (first treatment evaluation, discharge summary hospitalization results, first treatment past case history, discharge summary hospitalization progression, future discharge summary plans, first treatment family history, etc.) for each menu provided by the patient information input portion 150. The dialog box is configured so that if the user selects a relevant item, the user can view corresponding medical record forms. At this time, the listed medical record forms are medical record forms for a clinical department that the user, who desires to register or read the medical record forms, is authorized to use as described above. At this time, the user is allowed to delete unnecessary medical record forms as described above. In addition, in the case where the user desires to register new medical record forms, the user can retrieve the medical record forms stored in his/her terminal 20 or in another online computer and upload the record forms to the medical record form-managing unit 17.

That is, the user will be able to input a variety of medical information by directly formulating medical record forms required by the user or each clinical department as well as basically provided medical record forms, storing the medical record forms in the medical record form-managing unit 17, and thereafter fetching the medical record forms via the patient information input portion 150.

Further, the information input into the medical record form is stored in the patient information-managing unit 13 and can be read through the patient information inspection portion 140.

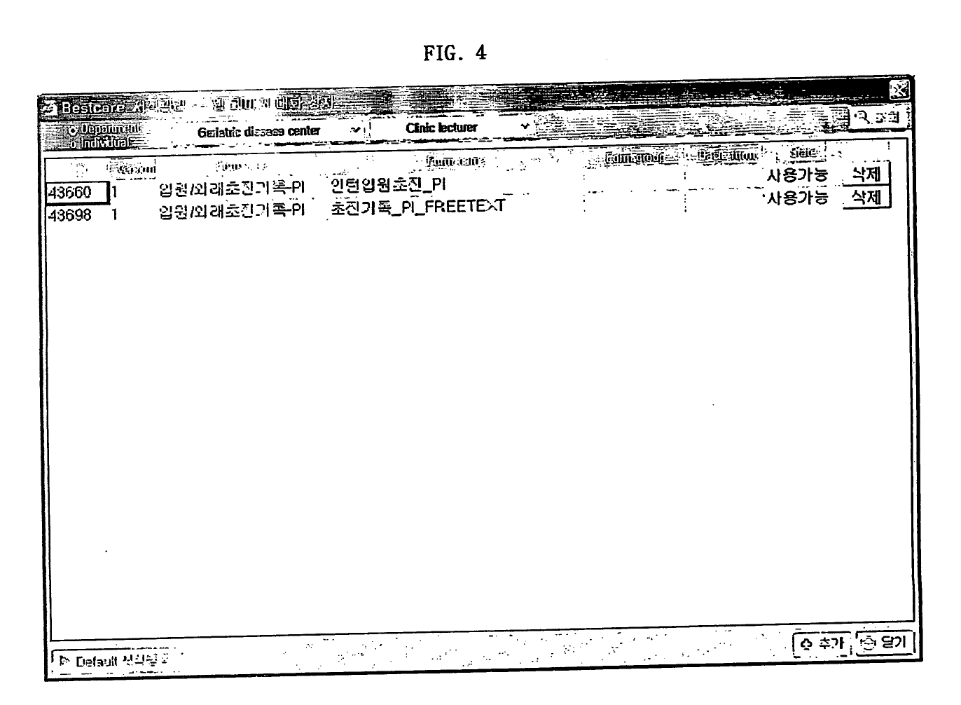

FIG. 4 is a diagram illustrating an example of a web page dialog box for setting a basic value of a medical record form that is applied to the method for the online management of medical record forms according to the present invention.

As described above, the patient information input portion 150 of the doctor web screen includes common menus, which will be used commonly by doctors, such as first ambulatory treatment, ambulatory progression, first hospitalization treatment, hospitalization progression, requests by other departments, surgical operation records, and hospital discharge records.

However, even though the menus are menus for recodes that can be used by all doctors in common, a medical record form to which medical information on patients will be substantially input may vary depending on each clinical department or patient. For example, even in the case of first ambulatory treatment, the type medical record forms for first ambulatory treatment, to which medical information on patients will be substantially input, varies according to a given department or departments such as the surgery department, internal treatment department, ophthalmic department, otorhinolaryngology department, and obstetrics and gynecology department.

Accordingly, even though a user selects the first ambulatory treatment menu, a sub-menu for selecting different forms of medical record forms may be included in the first ambulatory treatment menu.

Further, the department based record forms, or medical record forms provided by a medical certificate/written request menu as well as the common record forms include numerous medical record forms for each department or according to the type of medical certificate and written request, as described above. A selection menu for enabling the user to select a desired medical record form may be included.

Meanwhile, since having a user (doctor) retrieve and select medical record forms one by one when the user selects any one of the common menus causes inconvenience, the present invention stores a medical record form that forms a basis for each treatment in advance and outputs pre-set medical record forms by using user's login ID.

For example, the control unit 12 of the service-providing system 10 stores login information on users. Then, if the user selects the first ambulatory treatment menu, the control unit 12 will be able to output the medical record form of the first ambulatory treatment menu, which has been set in advance at any department where the patient has been cared for, through the patient information input portion 150.

However, setting the basic value for the medical record form as describe above is not only by a manager in each clinical department, and each doctor may individually set a desired medical record form as a basic value for his/her use. That is, as described above, since there may be differences in the detailed forms of medical record forms according to patients and properties of a treatment method as well as there are a variety of medical record forms, it is always not easy to set basic medical record forms for each clinical department.

Accordingly, each patient or each manager in the clinical department may select a menu for setting-up basic values of medical record forms in the main menu portion 130. FIG. 4 shows an example of a dialog box output when such a menu is selected.

That is, the patient or the manager in each clinical department can register, delete and modify a medical record form to be used as a default by each menu in the record selection column 151 among numerous medical record forms used in the patient information input portion 150.

That is, with respect to the department based record forms or the medical record forms available from the medical certificate/written request menu as well as medical record forms available from the common menu, the user can set up medical record forms to be output as a default by the above-described method if the user selects the relevant menu.

Further, with respect to sub-menus that appear when the user selects the menu, it is possible to set up basic values for medical record forms available from the relevant sub-menu through the above-described method and the dialog box.

That is, according to the present invention, new medical record forms can be registered according to the selection of patients or managers as described above, and default values for medical record forms displayed on each screen or menu can be directly selected by the respective doctors or managers, such that the doctors input and read the medical information on patients more quickly while the doctors treatment the patients.

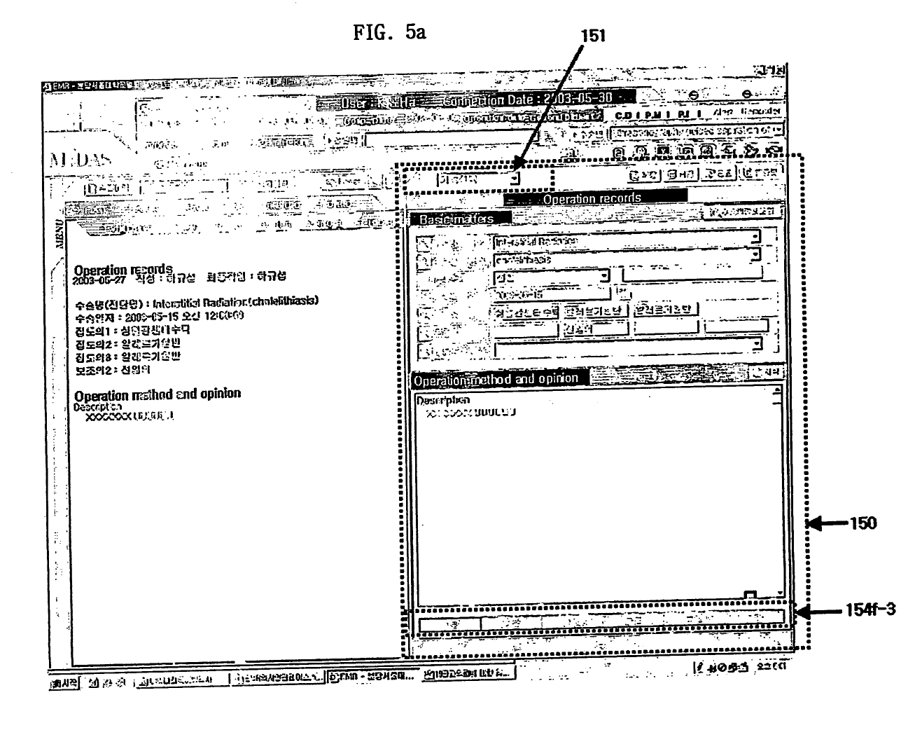

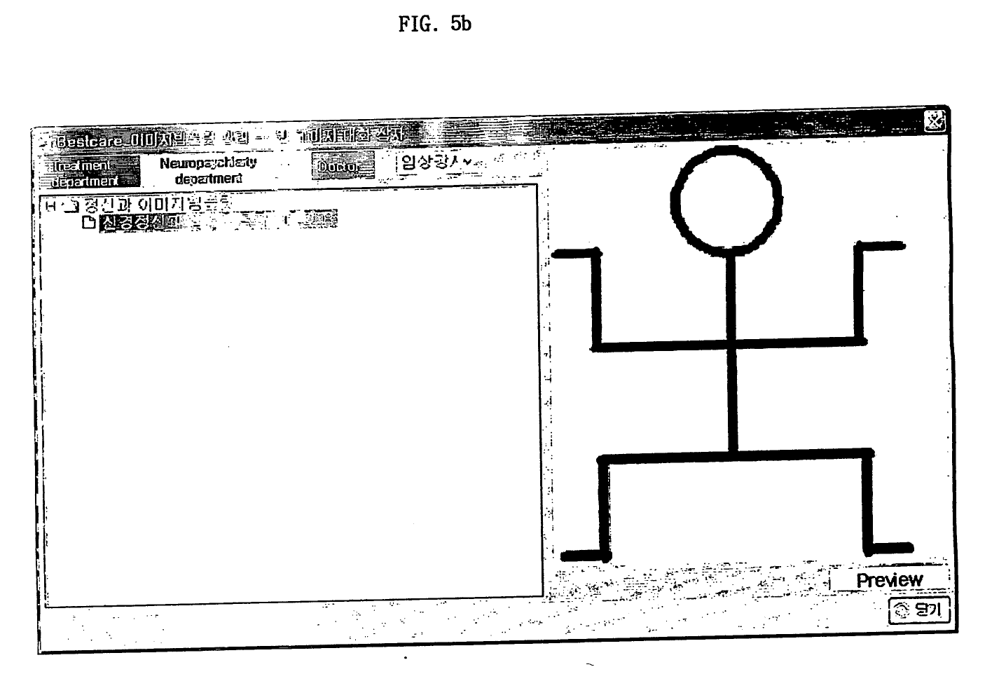

FIG. 5a is a diagram illustrating another example of a doctor web screen that is applied to a method for the online management of medical record forms according to the present invention, and FIG. 5b is a diagram illustrating an example of a web page dialog box for image management that is applied to a method for the online management of medical record forms according to the present invention.

As described above, the patient information input portion 150 of the doctor web screen includes the record selection column 151 in which menus, such as first ambulatory treatment, ambulatory progression, first hospitalization treatment, hospitalization progression, requests by other departments, operation records, hospital discharge records, department based documents, medical certificates and written requests, and psychiatric department diagnosis evaluations, may be selected. There may a medical record form, to which various images are required to be added, among various medical record forms provided through the menu.

That is, images, such as an X-ray photograph photographed in a X-ray photographing room, an endoscope photograph, or the like (hereinafter, referred briefly to as “photographed images”), are required to be appended to the medical record form of an ambulatory progression or operation record menu.

For example, as shown in FIG. 5a, there is an image addition menu 154f-3 for the registration of various images, in the medical record form of the operation record menu of the menus. If the doctor feels a need for storing a photographed image of a surgical operation while arranging the surgical operation records for patients, the doctor selects the image addition menu 154f-3 and thereafter can select and register the photographed images that have been stored in the doctor terminal 20 or a terminal connected with the doctor terminal 20 via the network. At this time, the selected photographed images will be stored in the patient information-managing unit 13 or the image information-managing unit 14 along with other medical information on patients.

Meanwhile, the method in which the doctor directly selects and registers the photographed images photographed at various laboratories or the like through the image addition menus 154f-3 provided in the medical record form has been described in the foregoing. However, when the doctor cares for patients, the doctor may have to utilize general material images that have been previously photographed as well as photographed images obtained by directly photographing patients as described above.

That is, it is preferable that images used for illustration and comparison other than photographed images obtained by photographing patients, such as a typical tissue structure for a wound portion of the patient, a typical bone structure, a tooth structure, and the like (hereinafter, referred briefly to as “image templates”) are managed through the image managing unit 14 of the service-providing system or a separate managing unit and thereafter are used when the doctors need them.

For this purpose, according to the present invention, each doctor or the manager for each clinical department can manage the above-stated image templates through the dialog box shown in FIG. 5b. That is, the doctor or the manager for each clinical department may select an image template management menu in the main menu portion 130 of the doctor web screen, wherein the output dialog box is shown in FIG. 5b.

Meanwhile, the doctor or the manager for each clinical department, as mentioned in the description on FIG. 3, can register a new image template and also can read, delete and modify existing image templates by applying the method of reading, registering, deleting and modifying the medical record forms through the dialog box.

Further, the user may classify and store the respective image templates according to each treatment department and medical record form.

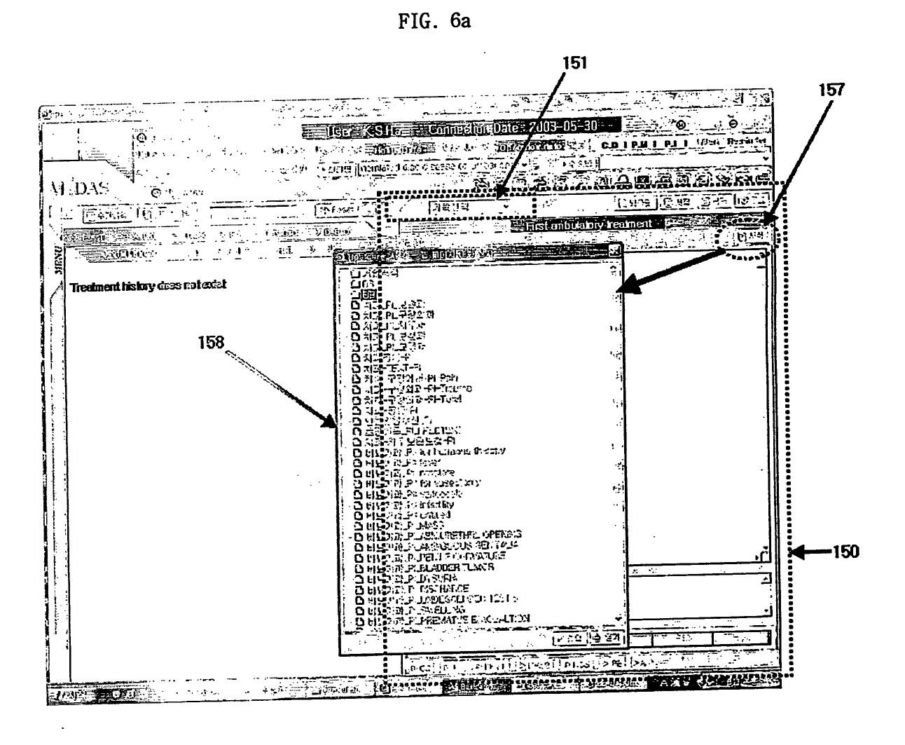

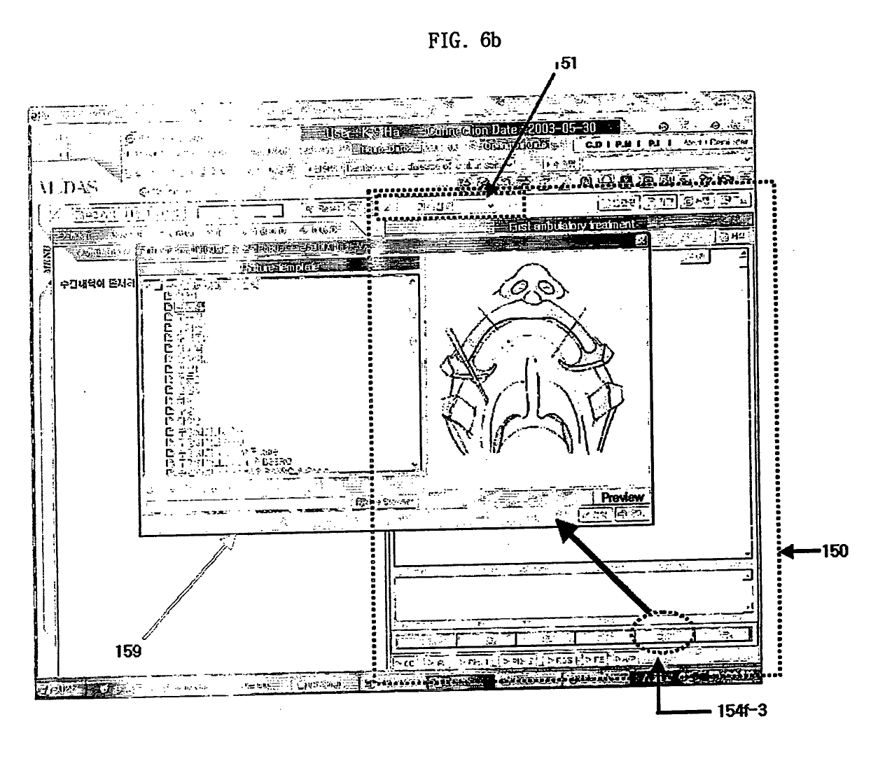

FIG. 6a is a diagram illustrating an example of a doctor web screen that embodies a method for the online management of medical record forms according to the present invention, and illustrates a screen on which a user can read and select various medical record forms that have been registered on a first ambulatory treatment menu. FIG. 6b is a diagram illustrating another example of a doctor web screen that embodies a method for the online management of medical record forms according to the present invention, and illustrates a screen on which a user can selects an image template on the first ambulatory treatment menu or register a photographed image.

That is, FIG. 6a illustrates a state in which a user substantially uses various medical record forms that have been registered according to the above-described method, through the doctor web screen. As shown, if the user selects the first ambulatory treatment menu from the record selection column 151 of the patient information input portion 150 on the doctor web screen, a medical record form set according to the method discussed in the description on FIG. 4 is output as a default through the patient information input portion 150.

At this time, the doctor, who desires to input the medical information on patients, may input various medical information using the medical record form, but if the output medical record form is not the desired medical record form, the doctor may select a desired medical record form through the medical record form dialog box 158 appeared by selecting a form menu 157 present in the patient information input portion 150.

That is, the medical record form dialog box 158 is a list of medical record forms that have been stored in the medical record form-managing unit 17 according to the method discussed in the description on FIG. 3, and if the patient selects any one form from the list, the selected medical record form is output on the patient information input portion 150 so that the doctor can input medical information on patients.

Meanwhile, FIG. 6b illustrates a state in which a doctor substantially uses various image templates or photographed images registered according to the above-described method, through a doctor web screen. As shown, if the user selects a first ambulatory treatment menu from the record selection column 151 of the patient information input portion 150 in the doctor web screen, a medical record form set according to the method discussed in the description on FIG. 4 is output as a default through the patient information input portion 150.

At this time, a doctor who desires to input medical information on patients, as described above in the description on FIG. 6a, may input a desired image template along with the patient information after selecting the medical record form as well as may select the desired medical record form.

That is, in a process that the doctor inputs various medical information on patients related to first ambulatory treatment, the doctor will select any one in the image addition menu 154f-3 present in the patient information input portion 150 when desiring to input an image template or a photographed patient image. At this time, an image dialog box 159 as shown in FIG. 6b will be output.

At this time, the image templates output on the image dialog box 159 are the image templates that have been stored in the image managing unit 14 of the service-providing system by the method as discussed above in the description on FIGS. 5a and 5b.

Meanwhile, the doctor will select a desired image from the image template list that has been output on the image dialog box 159 and store the selected image in the service-providing system along with other medical information on patients.

However, as described above, the images that can be input by the doctor are not limited to the image templates stored and managed in the image managing unit 14, and the doctor may select and input a photographed image that has been stored in the doctor terminal 20 or another terminal connected with the doctor terminal over the network. That is, the image dialog box 159 shown in FIG. 6b includes an image file upload menu and, using the upload menu, the doctor can store the photographed image, which is present in the terminal, in the service-providing system via the patient information input portion 150.

That is, the method for the online management of medical record forms according to the present invention provides a method capable of adding, deleting and modifying various images depending on the selection of the user as well as a method capable of adding, deleting and modifying various medical record forms depending on the selection of the user.

Further, the present invention provides a method in which a medical record form output as a default on the doctor web screen can be selected and modified for each patient or each clinical department.

Further, the present invention is not limited to the above-described methods, and may be applied to a method of allowing a user to modify or add medical record forms or images into a variety of forms according to preference of the user.

The present invention described above is not limited to the above-described embodiments. A variety of variations and modifications may be made to the present invention by those skilled in the art, and are included to the spirit and scope of the present invention defined in the accompanying claims.

### INDUSTRIAL APPLICABILITY

The present invention as described above is to eliminate inconvenience wherein a doctor, a nurse, and a laboratory staff input treatment, nursing treatment, examinations, and treatment information on patients using paper charts in the hospital. There is an advantage in that a doctor, a nurse, and a laboratory staff can treatment, nurse, examine, and treat patients in a more accurate and convenient manner by storing a variety of information input through a user terminal connected via a network, and then providing relevant information to the user terminal via the network when the user requests the relevant information.

Further, according to the present invention, there is provided a method in which various medical record forms and images provided to a user terminal via a network can be added, deleted and modified according to the selection of a user. Thus, there is an advantage in that users input and read medical information on patients more conveniently and rapidly.

Further, according to the present invention, there is provided a method for allowing a user to directly select or modify a default medical record form output on a user terminal. Therefore, there is an advantage in that a user's task efficiency increases.

1. A method for the online management of medical record forms, the method being applicable to a medical information-providing system, and comprising:
a first step of managing medical information required for treating patients in such a manner that a service-providing system (10) transmits a doctor web screen, a nurse web screen, and an laboratory web screen for medical information management to a doctor terminal (20), a nurse terminal (30), and an laboratory staff terminal (40) connected to the service-providing system (10) over the Internet or an Intranet, respectively, and stores information input through the web screens from the terminals to share the information through the respective web screens;
a second step of, by the service-providing system (10), providing a menu on the web screens, the menu allowing a user to add, delete and modify the medical record forms provided through the web screens so that the user inputs medical information on patients, and storing the added, deleted and modified medical record forms;
a third step of, by the service-providing system (10), providing a list of the stored medical record forms if there is a request for inspection of the list, and providing the medical record forms selected from the list through the web screens; and
a fourth step of, by the service-providing system (10), providing a menu through the web screens, the menu allowing the user to directly select a medical record form provided as a default record form through the web screens, and providing the selected medical record form as a default document through the web screens.

2. The method as claimed in claim 1, further comprising:
a fifth step of, by the service-providing system (10), providing a menu through the web screens, the menu allowing the users to insert an image into the medical record forms,
wherein the image is either a photographed image obtained by photographing a wound portion of a patient or an image template used for illustration, and is stored together with the medical information on patients input into the medical record forms.

3. The method as claimed in claim 2, wherein the photographed image is stored in at least one of the doctor terminal (20), the nurse terminal (30), and the laboratory terminal (40), is uploaded to the service-providing system through the menu enabling the insertion of the image, and is stored together with the medical information on patients.

4. The method as claimed in claim 2, wherein the image template used for illustration can be uploaded to or modified or deleted in the service-providing system by means of an image template management menu provided on the web screens, and the uploaded or modified image template is stored in a folder designated by the user or automatically in a folder designated according to the user information and is stored together with the medical information on patients through the menu enabling the insertion of the image.

5. The method as claimed in claim 1, wherein the medical record forms can be classified and managed according to doctors or treatment departments, and authority to add, delete and modify the medical record forms can be limited.

6. The method as claimed in claim 2, wherein the medical record forms can be classified and managed according to doctors or treatment departments, and authority to add, delete and modify the medical record forms can be limited.

7. The method as claimed in claim 3, wherein the medical record forms can be classified and managed according to doctors or treatment departments, and authority to add, delete and modify the medical record forms can be limited.

8. The method as claimed in claim 4, wherein the medical record forms can be classified and managed according to doctors or treatment departments, and authority to add, delete and modify the medical record forms can be limited.
